(19) United States
(12) Patent Application Publication
(10) Pub. No.: US 2026/0249740 A1
(43) Pub. Date: Aug. 27, 2026

(54) VOLTAGE BASED AUTOMATIC ELECTRICAL LOAD SHEDDING

(71) Applicant: Textron Inc., Providence, RI (US)

(72) Inventors: Matthew Jacob Noftsger, Evans, GA (US); Gregory August Theodosakis, Martinez, GA (US); Russell William King, Evans, GA (US)

(73) Assignee: Textron Inc., Providence, RI (US)

(21) Appl. No.: 19/064,171

(22) Filed: Feb. 26, 2025

(51) Int. Cl. B60L 58/12; B60L 1/00; B60L 7/10; B60L 15/20; B60L 58/16; H01M 10/42; H02J 7/00

(52) U.S. Cl. CPC B60L 58/12; B60L 1/00; B60L 7/10; B60L 15/20; B60L 58/16; H01M 10/425; H02J 7/663; B60L 2200/22; B60L 2240/547; H01M 2010/4271; H01M 2010/4278; H01M 2220/20

(57) ABSTRACT

A recreational vehicle includes a prime mover, an accessory, a battery configured to supply current to the prime mover, a sensor configured to acquire sensor data regarding operation of the battery, and a control system. The control system is configured to determine, based on the sensor data, a state of charge (SOC) of the battery. The control system is configured to reduce a supply of current from the battery to the accessory, responsive to a determination that the SOC is below a predetermined threshold, thereby decreasing a discharge rate of the battery and increasing a proportion of the SOC of the battery available to the prime mover.

### BACKGROUND

The present disclosure relates generally to outdoor equipment, such as recreational vehicles or off-road machines. More specifically, the present disclosure relates to determining and controlling electrical loads for recreational vehicles.

### SUMMARY

One embodiment relates to a recreational vehicle. The recreational vehicle includes a prime mover, an accessory, a battery configured to supply current to the prime mover, a sensor configured to acquire sensor data regarding operation of the battery, and a control system. The control system is configured to determine, based on the sensor data, a state of charge (SOC) of the battery. The control system is configured to reduce a supply of current from the battery to the accessory, responsive to a determination that the SOC is below a predetermined threshold, thereby decreasing a discharge rate of the battery and increasing a proportion of the SOC of the battery available to the prime mover.

Another embodiment relates to a vehicle. The vehicle includes an electric motor, an accessory, a battery configured to provide a supply of current to the electric motor and the accessory, and a control system. The control system includes at least one of (a) a breaker positioned between the battery and the accessory, the breaker configured to be in an open position when a voltage of the battery is below a voltage threshold to stop the supply of current to the accessory, or (b) a motor controller configured to reduce the supply of current from the battery to the electric motor in response to at least one of (i) a determination that the breaker is open or (ii) the voltage indicating that a state of charge (SOC) of the battery is below a SOC threshold.

Still another embodiment relates to a vehicle system. The vehicle system includes a non-transitory computer-readable medium having instructions stored thereon. The instructions, when executed by one or more processors, cause the one or more processors to determine a state of charge (SOC) of a battery of a golf vehicle, the SOC corresponding to a voltage of the battery, compare the SOC of the battery to a first predetermined threshold, reduce a first supply of current from the battery to a first accessory of the golf vehicle in response to the SOC being less than the first predetermined threshold, compare the SOC of the battery to a second predetermined threshold where the second predetermined threshold corresponds to a lower SOC than the first predetermined threshold, and reduce a second supply of current to at least one of a second accessory or an electric motor of the golf vehicle in response to the SOC being less than the second predetermined threshold.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is another schematic block diagram of the vehicle of FIG. 1, according to an exemplary embodiment.

FIG. 4 is a schematic block diagram of a fleet monitoring and control system including a plurality of the vehicles of FIG. 1, according to an exemplary embodiment.

FIG. 5 is a flow diagram of a method for electrical load shedding for the vehicle of FIG. 1 with an electric motor prime mover, according to an exemplary embodiment.

FIG. 6 is a flow diagram of a method for electrical load shedding for the vehicle of FIG. 1, with an internal combustion engine prime mover, according to an exemplary embodiment.

FIG. 7 is a schematic block diagram of an electrical load shedding system of the vehicle of

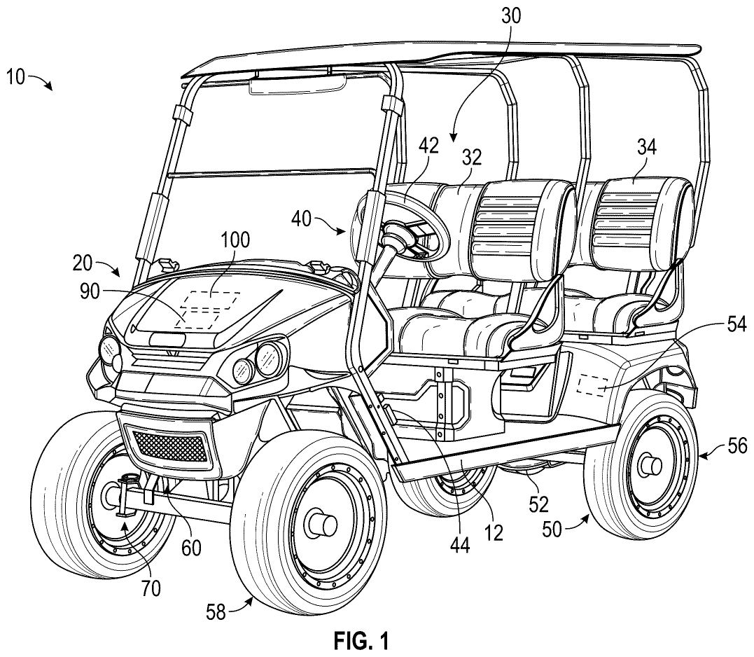

FIG. 1, according to an exemplary embodiment.

FIG. 8 is a flow diagram of a method for dynamic electrical load shedding for an electric and/or hybrid vehicle, according to an exemplary embodiment.

FIG. 9 is a flow diagram of a method for dynamic electrical load shedding for an internal combustion and/or hybrid vehicle, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

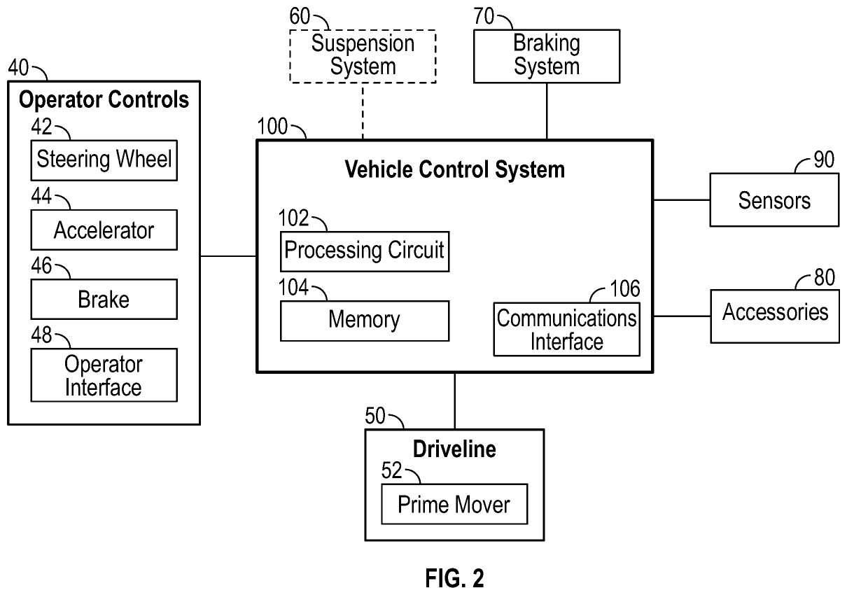

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a control system, shown as vehicle control system 100, coupled to the operator controls 40, the driveline 50, the suspension system 60, the braking system 70, and the sensors 90. In some embodiments, the vehicle 10 includes more or fewer components.

According to an exemplary embodiment, the vehicle 10 is an off-road machine or vehicle. In some embodiments, the off-road machine or vehicle is a lightweight or recreational machine or vehicle such as a golf cart or vehicle, an all-terrain vehicle (“ATV”), a utility task vehicle (“UTV”), a low speed vehicle (“LSV”), a personal transport vehicle (“PTV”), and/or another type of lightweight or recreational machine or vehicle. In some embodiments, the off-road machine or vehicle is a chore product such as a lawnmower, a turf mower, a push mower, a ride-on mower, a stand-on mower, aerator, a hauler, turf sprayers, bunker rake, and/or another type of chore product (e.g., that may be used on a golf course).

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a LCD display, a LED display, a speedometer, gauges, warning lights, etc. The one or more input device may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor (e.g., the motor 53) and the energy storage 54 is a battery system (e.g., the battery module 57, the add-on battery module(s) 59, etc.). In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, electric regenerative braking is employed (e.g., via the prime mover 52, an electric motor, etc.) in combination with or instead of using the braking system 70 to facilitate braking of one or more components of the driveline 50.

The accessories 80 may include various electronic devices positioned about the vehicle 10 to perform non-driving operations. By way of example, the accessories 80 may include a USB charger, headlights, taillights, a media display, seat adjustment motors, accent lights, speakers, cameras, navigation systems, air conditioning, alarm systems, Bluetooth systems, and/or other devices of the vehicle 10 regarding non-driving operations. One or more of the accessories 80 may be configured to receive current from the energy storage 54 at all times when the vehicle 10 is operational. One or more of the accessories 80 may be configured to receive current from the energy storage 54 upon activation by an operator of the vehicle 10.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, a Doppler sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle control system 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle control system 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle control system 100 may represent a collection of processing devices. In such cases, the processing circuit 102 represents the collective processors of the devices, and the memory 104 represents the collective storage devices of the devices.

In one embodiment, the vehicle control system 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle control system 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle control system 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

### Electrified Driveline

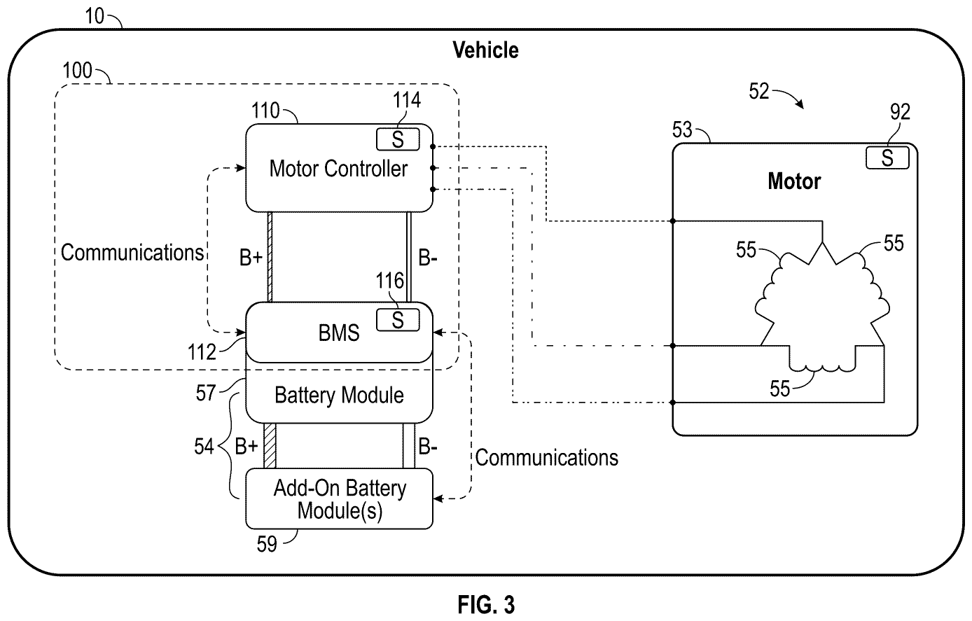

According to the exemplary embodiments shown in FIG. 3, the driveline 50 of the vehicle 10 is configured as an electrified driveline where (a) the prime mover 52 is configured as a three-phase, alternating current (“AC”) electric motor, shown as motor 53, including three sets of windings, shown as motor windings 55, and a first sensor, shown as motor sensor 92; (b) the energy storage 54 is configured as a battery system including a first battery pack or module, shown as battery module 57, and one or more second battery packs or modules, shown as add-on battery module(s) 59, electrically coupled to the battery module 57 in parallel; and (c) the vehicle control system 100 includes (i) a first controller, shown as motor controller 110, coupled to the motor 53 and including a second sensor, shown as motor controller sensor 114, and (ii) a second controller, shown as battery management system (“BMS”) 112, coupled to the motor controller 110 and the energy storage 54 (e.g., the battery system, the battery module 57, the add-on battery module(s) 59, etc.) and including a third sensor, shown as BMS sensor 116. In some embodiments, the motor 53 is configured as a separately excited DC motor. The motor sensor 92, the motor controller sensor 114, and/or the BMS sensor 116 may include a temperature sensor, a voltage sensor, a current sensor, a speed sensor, and/or another suitable sensor to facilitate monitoring at least one of the operational parameters (e.g., temperature, voltage, current, speed, SOC, rate of charge, rate of discharge, etc.) of the motor 53, the motor controller 110, the BMS 112, the battery module 57, and/or the add-on battery modules(s) 59. The motor controller 110 and the BMS 112 may each include a processing circuit 102, a memory 104, and a communications interface 106.

According to an exemplary embodiment, each of the battery module 57 and the add-on battery module(s) 59 of the battery system includes one or more rows and/or groups of battery cells. The BMS 112 may be configured to monitor characteristics of the rows and/or groups of battery cells and/or individual cells of the battery module 57 and the add-on battery module(s) 59 (e.g., using data acquired by the BMS sensor 116) including, but not limited to, voltage, temperature, current, and state of charge (“SOC”). The BMS 112 may also be configured to provide direct current (“DC”) power from the battery system to the motor controller 110 to power the motor 53 based on driving demands of the vehicle 10. In some embodiments, the battery cells of the battery module 57 and the add-on battery module(s) 59 are lithium-ion batteries connected in parallel. In other embodiments, the battery cells of the battery module 57 and the add-on battery module(s) 59 are lead acid batteries connected in series.

According to an exemplary embodiment, the motor controller 110 is configured to manage the power supplied to the motor 53. By way of example, the motor controller 110 may be configured to modulate the voltage, current, phase, and/or frequency of the power sent to the motor windings 55, which can influence the torque and speed output provided by the motor 53. In some embodiments, the motor controller 110 is configured to control a type of power, AC power or DC power, delivered to the motor 53. By way of example, the motor controller 110 may be configured to convert the type of power from DC power to AC power and/or regulate the AC power or DC power depending on the intended function of the motor 53. The motor controller 110 may include components to invert, convert, or otherwise modulate DC power and/or AC power.

As shown in FIG. 3, the energy storage 54 is configured to supply (e.g., via electrical wiring, electrical connections, etc.) DC power to the motor controller 110. In some embodiments, the DC power flows from the energy storage 54, through the BMS 112, and to the motor controller 110. The BMS 112 and the motor controller 110 may include communication interfaces (e.g., communications interfaces 106) that facilitate exchanging data related to operational status, command signals, and feedback therebetween. The BMS 112 and the add-on battery module 59 (e.g., a BMS thereof) may include communication interfaces that facilitate exchanging data related to operational status, command signals, and feedback therebetween. The add-on battery module(s) 59 is(are) configured to provide additional battery cells and increase the total energy storage capacity of the energy storage 54. As shown in FIG. 3, the battery module 57 and the add-on battery module(s) 59 are connected in parallel (e.g., via wires, connection busses, etc.) to provide for a pathway of electrical transfer. In other embodiments, the battery module 57 and the add-on battery module(s) 59 are connected in series.

According to an exemplary embodiment, the BMS 112 is configured to monitor (e.g., continuously, periodically, etc.) various parameters of the energy storage 54, including voltage, current, and temperature of each cell, rows/groups, and/or module within the energy storage 54. In some embodiments, the BMS 112 is configured to calculate or otherwise determine the SOC of the energy storage 54, the battery module 57, and/or the add-on battery module(s) 59. As referred to herein, the SOC of the battery may correspond to a percentage of remaining battery capacity, the rate of charge/discharge of the battery system, and/or any other metric relating to battery capacity.

In some embodiments, the BMS 112 is configured to redistribute charge among the cells, rows/groups, and/or the modules to ensure an equal or substantially equal charge level throughout the energy storage 54. The BMS 112 can communicate with other systems or components or the vehicle 10 or with external devices (e.g., the remote systems 240) to report on battery status and diagnostics and/or to receive control commands.

According to an exemplary embodiment, the BMS 112 is configured to detect faults or failures in the energy storage 54 that may potentially lead to or that have caused an overcharge condition and, thereby, a thermal runaway event. By way of example, the BMS 112 may be configured to monitor the voltage of individual cells, rows/groups, or modules of the energy storage 54, and when deviations from normal voltage levels occur beyond a nominal range, the BMS 112 may determine that a fault or failure is present and that there is a potential for an overcharge condition or that there is an actual overcharge condition. In some implementations, the BMS 112 is configured to detect voltage imbalance or voltage imbalance trends. By way of another example, the BMS 112 may additionally or alternatively be configured to monitor current flows during charging and discharging of the energy storage 54 and identify unexpected fluctuations in current that may indicate that a fault or failure is present and that there is a potential for an overcharge condition or that there is an actual overcharge condition. By way of still another example, the BMS 112 may additionally or alternatively be configured to monitor the temperature of the cells, rows/groups, and/or modules of the energy storage 54 and identify anomalously high temperatures that may indicate that a fault or failure is present and that there is a potential for an overcharge condition or that there is an actual overcharge condition. It should be understood that the above example of detecting faults, failures, or overcharge conditions is provided for example purposes only and is not exhaustive. Other methods or techniques may be implemented to detect faults, failures, or overcharge conditions, which are intended to be included within the scope of the present disclosure. Additional details regarding fault detection regarding the energy storage 54 is described in greater detail herein. Further details regarding fault detection, including voltage imbalance, may be found in U.S. patent application Ser. No. 18/884,363, filed Sep. 13, 2024, which is incorporated herein by reference in its entirety.

### Fleet Monitoring and Control System

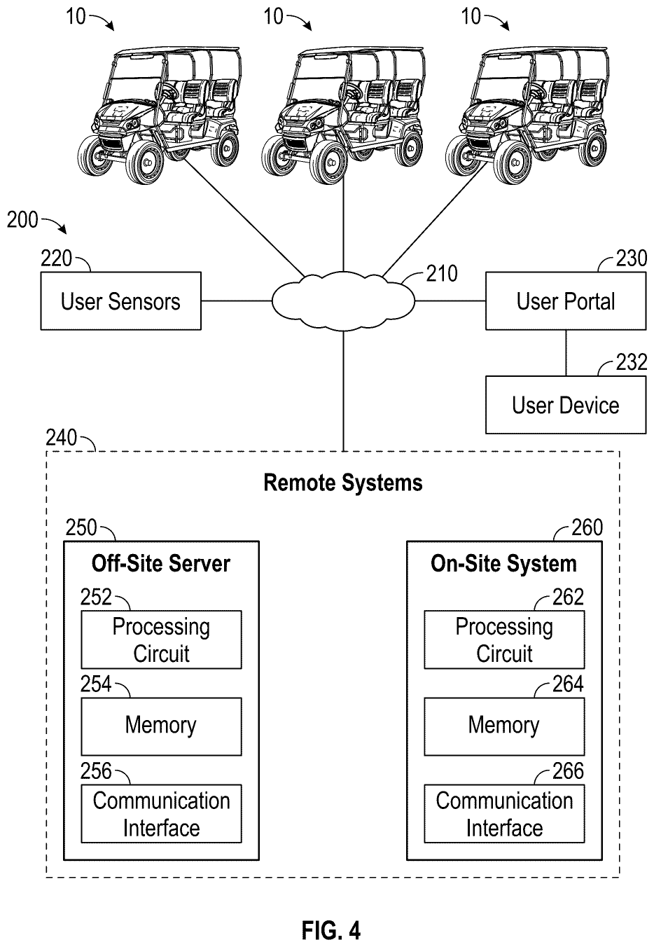

As shown in FIG. 4, a site monitoring and control system, shown as fleet monitoring and control system 200, includes one or more vehicles 10; one or more second sensors, shown as user sensors 220, positioned remote or separate from the vehicles 10; an operator interface, shown as user portal 230, positioned remote or separate from the vehicles 10; an external or remote user device, shown as user device 232, positioned remote or separate from the vehicles 10; and one or more external processing systems, shown as remote systems 240, positioned remote or separate from the vehicles 10. The vehicles 10, the user sensors 220, the user portal 230, and the remote systems 240 communicate via one or more communications protocols (e.g., Bluetooth, Wi-Fi, cellular, radio, through the Internet, etc.) through a network, shown as communications network 210. In some embodiments, the fleet monitoring and control system 200 does not include the user portal 230 and/or the user device 232.

The user sensors 220 may be or include one or more sensors that are carried by or worn by an operator of one of the vehicles 10. By way of example, the user sensors 220 may be or include a wearable sensor (e.g., a smartwatch, a fitness tracker, a pedometer, a heart rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc. ; location; movement; etc.) regarding the operator. The user sensors 220 may communicate directly with the vehicles 10, directly with the remote systems 240, and/or indirectly with the remote systems 240 (e.g., through the vehicles 10 as an intermediary).

The user portal 230 may be configured to facilitate operator access to dashboards including the vehicle data, the operator data, information available at the remote systems 240, etc. to manage and operate the site (e.g., golf course) such as for advanced scheduling purposes, to identify persons breaking course guidelines or rules, to monitor locations of the vehicles 10, etc. The user portal 230 may also be configured to facilitate operator implementation of configurations and/or parameters for the vehicles 10 and/or the site (e.g., setting speed limits, setting geofences, etc.). As shown in FIG. 4, the user portal 230 is accessible via the user device 232. The user device 232 may be or include a computer, laptop, smartphone, tablet, or the like. The user portal 230 and the user device 232 may communicate via one or more communications protocols (e.g., Bluetooth, Wi-Fi, cellular, radio, through the Internet, wired connection, etc.) through a network (e.g., a CAN bus, the communications network 210, etc.). The user device 232 includes a display (e.g., a screen, etc.) configured to display one or more graphical user interfaces (“GUIs”) of the user portal 230.

As shown in FIG. 4, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 4, (a) the off-site server 250 includes a processing circuit 252, a memory 254, and a communications interface 256 and (b) the on-site system 260 includes a processing circuit 262, a memory 264, and a communications interface 266.

According to an exemplary embodiment, the remote systems 240 (e.g., the off-site server 250 and/or the on-site system 260) are configured to communicate with the vehicles 10 and/or the user sensors 220 via the communications network 210. By way of example, the remote systems 240 may receive the vehicle data from the vehicles 10 and/or the operator data from the user sensors 220. The remote systems 240 may be configured to perform back-end processing of the vehicle data and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10 and/or the user sensors 220. The remote systems 240 may be configured to transmit information, data, commands, and/or instructions to the vehicles 10. By way of example, the remote systems 240 may be configured to transmit GPS data and/or RTK data based on the GPS information and/or RTK information to the vehicles 10 (e.g., which the vehicle control systems 100 may use to make control decisions). By way of another example, the remote systems 240 may send commands or instructions to the vehicles 10 to implement.

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10 and/or the operators thereof and/or (b) configuring or setting operating parameters for the vehicles 10 (e.g., geofences, speed limits, times of use, permitted operators, etc.). Such operating parameters may be propagated to the vehicles 10 by the remote systems 240 (e.g., as updates to settings) and/or used for real time control of the vehicles 10 by the remote systems 240.

### Electrical Load Shedding

It should be understood that any of the function or processes described herein with respect to the driveline 50 and the accessories 80 may be performed by the processing circuit 102, the motor controller 110, and/or the BMS 112. By way of example, the BMS 112 may be configured to control the battery system, and the motor controller 110 may be configured to control the prime mover 52. By way of another example, the processing circuit 102 may be configured to control (e.g., operate, configure) at least one of the battery system and/or the prime mover 52. By way of yet another example, the processing circuit 102 may be configured to control a first part of the driveline 50, the BMS 112 may be configured to control a second part of the driveline 50, and the motor controller may be configured to control a third part of the driveline 50.

As described herein, the prime mover 52 may be one of an electric motor (e.g., the motor 53), a hybrid system including an electric motor and an internal combustion engine, or just an internal combustion engine. As shown in FIGS. 2 and 3, the prime mover 52 and the accessories 80 are electrically coupled to the vehicle control system 100. In some embodiments, the prime mover 52 is configured to receive current from the battery system (e.g., BMS 112, battery module 57, energy storage 54). As the vehicle 10 operates, the battery system may deplete over time. By way of example, the prime mover 52 may use an amount of available energy from the battery system during operation. In some embodiments, the accessories 80 are configured to receive current from the battery system. As the vehicle 10 operates, the accessories 80 may receive current from the battery system, thereby depleting the battery system over time. By way of example, the accessories 80 may include an accent lighting system that draws current from the battery system during all times that the vehicle 10 is operating. By way of another example, the accessories 80 may include a speaker system that draws current from the battery system when an operator enables operation of the speaker system.

As the prime mover 52 and/or the accessories 80 draw current from the battery system, the amount of available energy may be depleted over time. As the available energy of the battery system is depleted, the voltage across the battery may decrease. By way of example, the voltage of the battery may decrease such that a measured voltage across the battery is less than a rated voltage of the battery. The vehicle control system 100 may be configured to detect the change in battery voltage. In some embodiments, the motor controller sensor 114 and/or the BMS sensor 116 are configured to determine the voltage across the battery system. In other embodiments, a different one of the sensors 90 is configured to determine the voltage across the battery system (e.g., a dedicated SOC or voltage sensor).

In other embodiments, the prime mover 52 includes an internal combustion engine or a hybrid system including an electric motor/generator (e.g., the motor 53) and the internal combustion engine. The prime mover 52 may be started (e.g., ignited, sparked, turned-on) by a battery system. By way of example, the prime mover 52 may be a spark-ignition internal combustion engine configured to be started by a battery system powering an engine starter. The electric motor/generator (e.g., the motor 53) may be configured to convert the kinetic energy of the internal combustion engine into electricity that may be used to charge (e.g., provide current to) the battery system. In such embodiments (e.g., where the prime mover includes an internal combustion engine and/or a motor/generator), the battery system may provide current to the accessories 80.

The battery system may provide current to the accessories 80 while being charged by the generator (e.g., the motor 53). By way of example, if the accessories 80 are operating while the prime mover 52 is in operation, the battery system may be simultaneously charging while providing current to the accessories 80. However, if the battery system is fully depleted or depleted beyond a threshold, the battery system may not have enough stored energy to restart the prime mover 52 during future operations. The sensors 90 may be used or otherwise operated to collect data regarding the current output (e.g., to the accessories 80) of the battery system relative to current input of the battery system (e.g., from the generator). By way of example, the motor controller sensor 114 may be configured to collect data regarding the supply of current from the generator (e.g., the motor 53) to the battery system. By way of another example, the BMS sensor 116 may be configured to collect data regarding the supply of current from the generator (e.g., the motor 53) to the battery system. The motor controller sensor 114, the BMS sensor 116, and/or a different one of the sensors 90 may be configured to collect data regarding the supply of current from the battery system to the accessories 80.

For a vehicle with a hybrid/electric prime mover 52, the vehicle control system 100 may be configured to use measured voltage readings from the sensors and/or other sensor data to determine the SOC of the battery system. In some embodiments, the SOC of the battery system corresponds to a percentage of remaining battery capacity. In other embodiments, the SOC of the battery system may correspond to a remaining drive time of the vehicle 10. To determine the SOC of the battery system, in some embodiments, the vehicle control system 100 compares the voltage of the battery to a rated voltage to determine the SOC of the battery system. In other embodiments, the vehicle control system 100 may analyze a look up table to determine a SOC based on the voltage of the battery system.

For a vehicle with a hybrid/internal combustion prime mover 52, the vehicle control system 100 may be configured to use sensor data (e.g., from the BMS sensor 116, the motor controller sensor 114, and/or other sensors 90) to determine the current input to the battery system relative to the current output of the battery system. From this, the vehicle control system 100 may be configured to infer or otherwise determine the SOC of the battery. In some embodiments, the SOC of the battery corresponds to a percentage of remaining battery capacity. In other embodiments, the SOC of the battery system may correspond to the rate of charge/discharge of the battery system. The sensor data may include voltage measurements of the battery. From the voltage measurements, the vehicle control system can infer or otherwise determine whether the net current flow of the battery is positive or negative.

In some embodiments, the prime mover 52 (e.g., the motor 53) is configured to facilitate regenerative braking in the driveline 50. The prime mover 52 may be used with and/or without the braking system 70. The prime mover 52 may be electrically coupled to the battery system (e.g., by way of the vehicle control system 100, the motor controller 110, and/or the BMS 112), and may be configured to supply current to the battery while the vehicle 10 is braking (e.g., stopping, slowing down, etc.).

The vehicle control system 100 may be configured to compare the SOC to a predetermined threshold. The predetermined threshold may be based on desired operations of the vehicle 10. In some embodiments, the predetermined threshold corresponds to a SOC where the discharge rate of the battery system should be decreased to prolong an amount of time that the prime mover 52 can operate. By way of example, the predetermined threshold may correspond to a SOC where the discharge rate of the battery system should be decreased to ensure the prime mover 52 can drive the vehicle 10 to a charging station. By way of another example, the predetermined threshold may correspond to a SOC where the discharge rate of the battery system should be decreased to ensure the prime mover 52 can operate for an amount of time set by the operator (e.g., via interaction with the operator interface 48). In other embodiments, the predetermined threshold may correspond to a SOC where battery is being degraded (e.g., walked down, depleted, etc.) by the accessories 80. By way of example, the threshold may correspond to a SOC where the battery cannot provide enough current to a starter motor to start an internal combustion engine.

In some embodiments, the vehicle control system 100 is configured to adjust the predetermined threshold based on a degradation (e.g., age, deterioration, etc.) value associated with the battery system. As batteries charge and recharge, they may lose functionality over time, leading to reduced performance. By way of example, the maximum capacity, efficiency rate, and/or the discharge rate may vary based on the state of the battery system. Accordingly, the vehicle control system 100 may use or otherwise operate the sensors 90 to collect data regarding the degradation of the battery system, and the vehicle control system 100 may analyze the data to adjust the predetermined SOC threshold according to and to compensate for the degradation.

The vehicle control system 100 may be configured to determine whether the SOC is below the predetermined threshold. If the SOC is below the predetermined threshold, the vehicle control system 100 may be configured to determine a load shedding operation. The load shedding operation may include adjusting or otherwise limiting a supply of current to one or more of the accessories 80 to decrease the amount of current being drawn from the battery system. For hybrid/electric motor prime mover 52 vehicles 10, adjusting current to the accessories 80 may decrease the discharge rate of the battery system. This may allow for an increase in the proportion of the SOC of the battery available to the prime mover 52 for use, thereby increasing the amount of time that the prime mover 52 can operate before the battery system is fully or critically depleted.

For hybrid and/or internal combustion engine prime mover 52 vehicles 10, adjusting current to the accessories 80 may decrease the discharge rate of the battery system. By way of example, this may allow for the conservation of current to be used for starting the prime mover 52. By way of another example, this may allow more time for the generator (e.g., the motor 53) to generate current to charge the battery. As used herein, adjusting current to the accessories 80 may include at least one of (i) decreasing the current demand of the accessory 80, (ii) decreasing the current supply to the accessory 80, or (iii) disabling current supply to the accessory 80.

In some embodiments, the vehicle control system 100 is configured to determine the current demand of each individual accessory 80. By way of example, the sensors 90 may be configured to collect data regarding the current consumption of each accessory 80. The vehicle control system 100 may be configured to adjust the current to the accessories 80 based on the determined current demand of each accessory 80. For example, if the SOC of the battery system is below the threshold, the vehicle control system 100 may be configured to adjust the current supply to the accessories 80 based on the difference between the SOC and the threshold. If the difference between the SOC and the threshold is low, the vehicle control system 100 may adjust a small load accessory 80. If the difference between the SOC and the threshold is high, the vehicle control system 100 may adjust a high load accessory 80.

In some embodiments, outside constraints on the vehicle 10 result in the vehicle control system shedding accessory 80 loads. By way of example, if the vehicle 10 is driving up a steep hill, more current may need to be drawn from the battery to the prime mover 52. Rather than increasing the current supply to the prime mover 52 (e.g., and increasing discharge rate of the battery system), the accessory 80 loads may be adjusted to ensure that the prime mover 52 has enough current to travel up the hill. Other outside constraints may include weather events, driving surface, distance travelled, traffic conditions, or other events occurring outside of the vehicle 10.

For hybrid and/or electric motor prime movers 52, the vehicle control system 100 may be configured to adjust (e.g., decrease, ramp down, etc.) current supplied to the prime mover 52 responsive to a determination that the SOC of the battery system is below at least the predetermined threshold. In some embodiments, the vehicle control system 100 does not adjust the current supply to the prime mover 52 until all accessory 80 loads have been shed. In other embodiments, the vehicle control system 100 may adjust the current supply to the prime mover 52 once the SOC falls below a second threshold where the second threshold is lower than the predetermined threshold.

The vehicle control system 100 may adjust the current supplied to the prime mover 52 by decreasing a current demand of the prime mover 52. By way of example, this may include decreasing the maximum speed of the vehicle 10. By way of another example, this may include reducing an acceleration rate of the vehicle 10. Additionally or alternatively, the vehicle control system 100 may adjust the current supplied to the prime mover 52 by reducing the capability of the battery system in supplying current to the prime mover 52. By way of example, the BMS 112 may reduce a maximum supply of current from the battery system to the prime mover 52, even if the battery system is physically capable of supplying more current.

In some embodiments, the vehicle control system 100 is configured to determine a period of inactivity (e.g., idling, stoppage, rest, etc.) of the prime mover 52. Specifically, the sensors 90 (e.g., the motor controller sensor 114, the BMS sensor 116, etc.) may be configured to detect activity of the prime mover 52. The vehicle control system 100 may be configured to disable (e.g., shut off) the supply of current from the battery system to the prime mover 52 and/or the accessories 80 responsive to a determination that the prime mover 52 has been inactive for a certain length of time. The vehicle control system 100 may be configured to adjust the length of inactivity time before disabling the prime mover 52 and/or the accessories 80 based on the SOC of the battery system. For example, if the SOC of the battery system is below the predetermined threshold, the time of inactivity before disabling may be shorter than if the SOC is above the predetermined threshold.

In some embodiments, the vehicle control system 100 is configured to automatically adjust the current supplied to the accessories 80 and/or the prime mover 52. For example, the vehicle control system 100 may automatically determine whether to adjust the current supply, and implement adjustments without operator intervention. In other embodiments, the vehicle control system 100 may request user authorization (e.g., permission, notification) before adjusting current supply to the accessories 80 and/or the prime mover 52. For example, the vehicle control system may transmit an instruction or notification to the operator interface 48 requesting authorization to adjust the current supply. Additionally or alternatively, the vehicle control system 100 may be configured to allow the user to manually override (e.g., disable, change, reject, etc.) adjustments made by the vehicle control system 100. By way of example, the operator interface 48 may include selectable elements that the operator can interact with to indicate to the vehicle control system 100 that the current supply to the prime mover 52 and/or accessories 80 should not be adjusted.

The vehicle control system 100 may actively monitor the SOC of the battery system and compare the SOC to the predetermined threshold. If the SOC of the battery system increases to be above the predetermined threshold (e.g., due to charging, generation, and/or regenerative breaking), the vehicle control system 100 may be configured to partially or fully restore the supply of current to the accessories 80 and/or to prime mover 52. By way of example, the vehicle control system 100 may restore the supply of current to essential accessories (e.g., headlights, GPS) before restoring the supply of current to non-essential accessories (e.g., Bluetooth, accent lights, infotainment systems, etc.). In some embodiments, the vehicle control system 100 is configured to partially or fully restore the supply of current to the accessories 80 and/or the prime mover 52 in response to the SOC of the battery system increasing above a restoration threshold. The restoration threshold may be associated with a SOC of the battery system that is greater than the predetermined threshold. A greater restoration threshold may facilitate accounting for hysteresis of the loads and prevent the system from quickly disabling loads once restored, allowing the system to appropriately recover and not restore the loads to early.

The vehicle 10 may be configured to transmit data associated with the battery system (e.g., SOC, the discharge rate, load shedding decisions, and/or other vehicle 10 data) to the remote systems 240. The remote systems 240 may be configured to store the vehicle 10 data (e.g., in memory 254) and collect historical data associated with the vehicle 10. In some embodiments, the remote systems 240 are configured to analyze the data associated with the vehicle 10 and/or other vehicles 10 to improve load shedding decision making. By way of example, the remote systems 240 may be configured to analyze or otherwise process trend data relating to discharge rates for the vehicles 10 and transmit an instruction to the vehicles 10 to adjust the predetermined threshold and/or the restoration threshold. The remote systems 240 may use reinforcement learning or a different machine learning model to adjust load shedding operations of the vehicles 10.

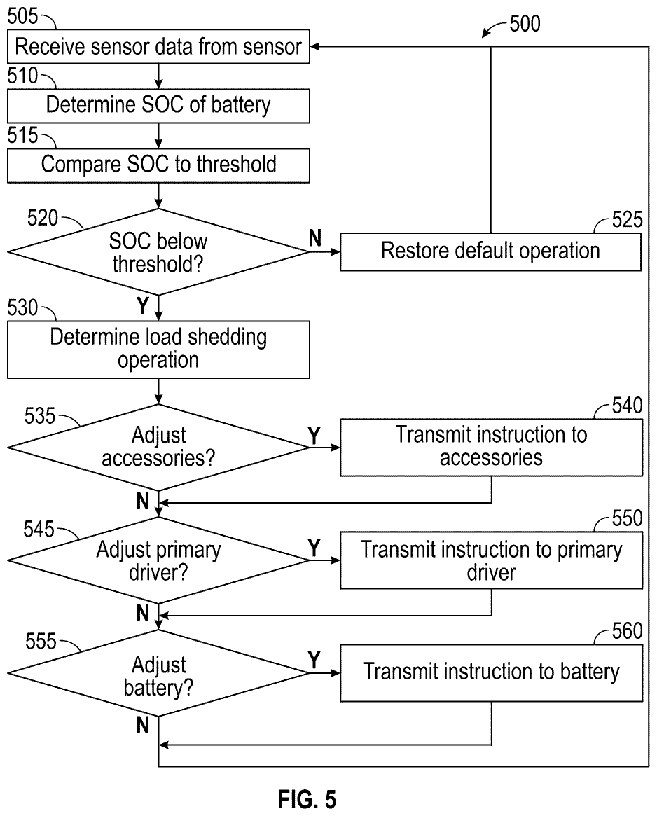

As shown in FIG. 5, depicted is a flow diagram of a method 500 for electrical load shedding for the vehicle 10 where the prime mover 52 of the driveline 50 includes the electric motor 53, according to an exemplary embodiment. At step 505 of method 500, the vehicle control system 100 receives sensor data from the sensors 90. Specifically, the vehicle control system 100 receives sensor data from the sensors 90 regarding operation of the battery system (e.g., energy storage 54, battery module 57, etc.). In some embodiments, the sensor data includes voltage measurements. The motor controller 110, the BMS 112, and/or the processing circuit 102 may be configured to receive the sensor data. The sensor data may be collected by the motor controller sensor 114, the BMS sensor 116, and/or another sensor 90.

At step 510 of method 500, the vehicle control system 100 is configured to determine a state of charge of the battery system. In some embodiments, the SOC of the battery system corresponds to a percentage of remaining battery capacity of the battery system. In other embodiments, the SOC of the battery system may correspond to a remaining drive time of the vehicle 10. To determine the SOC of the battery system, in some embodiments, the vehicle control system 100 compares the voltage of the battery to a rated voltage to determine the SOC of the battery system. In other embodiments, the vehicle control system 100 may analyze a look up table to determine a SOC based on the measured voltage of the battery system.

At step 515 of method 500, the vehicle control system 100 is configured to compare the SOC of the battery system to a predetermined threshold. Specifically, the predetermined threshold may be based on desired operations of the vehicle 10. In some embodiments, the predetermined threshold corresponds to a SOC where the discharge rate of the battery system should be decreased to prolong an amount of time that the prime mover 52 can operate. For example, the predetermined threshold may correspond to an SOC where GPS/location information indicates that the vehicle 10 can successfully return to a charging location. In other embodiments, the predetermined threshold may be based on a degradation value associated with the battery system. Specifically, the degradation value may be based on at least one of a maximum battery capacity, discharge rate, or other efficiency value. The predetermined threshold may be adjusted based on factors including conditions outside of the vehicle, degradation of the battery system, operator instructions (e.g., via the operator interface 48), or other vehicle 10 conditions.

At step 520 of method 500, the vehicle control system 100 is configured to determine whether the SOC of the battery system is below the predetermined threshold. Specifically, the vehicle control system 100 is configured to determine whether a load shedding operation is necessary to prolong the driving functionality of the primary driver 52. If the SOC is not below the predetermined threshold, the vehicle control system 100 is configured to determine that no load shedding operation is necessary and continues to receive sensor data from the sensors 90 to achieve active monitoring of the battery system until the SOC falls below the predetermined threshold.

At step 525 of method 500, if the SOC is above the predetermined threshold, the vehicle control system 100 is configured to restore default operation of the vehicle 10. Specifically, restoring default operation of the vehicle 10 may include restoring normal (e.g., default, rated) supplying of current to the prime mover 52 and/or the accessories 80. Specifically, restoring default operation of the vehicle 10 may include restoring normal (e.g., default) settings of the BMS 112, and removing any artificial limits on the supplying of current from the battery system. After restoring default operation of the vehicle 10, steps 505-520 may be repeated to achieve active monitoring of the vehicle 10.

At step 530 of method 500, the vehicle control system 100 is configured to determine a load shedding operation for the vehicle 10 is needed. In some embodiments, the load shedding operation includes adjusting or otherwise limiting a supply of current to one or more accessories 80 to decrease the amount of current being drawn from the battery system. Specifically, adjusting current to the accessories 80 may decrease the discharge rate of the battery system. This may allow for an increase in the proportion of the SOC of the battery available to the prime mover 52 for use, thereby increasing the amount of time that the prime mover 52 can operate before the battery system is fully depleted.

In some embodiments, the load shedding operation includes adjusting or otherwise limiting the primary driver 52 to decrease the amount of current drawn from the battery system. Specifically, this may include decreasing the functionality of the primary driver 52, such as the maximum speed and/or acceleration rate. In some embodiments, the load shedding operation includes adjusting or otherwise limiting the battery system to limit the amount of current being supplied to the primary driver 52. Specifically, the BMS 112 may place an artificial limit on the supply of current to the primary driver 52, the artificial limit being less than the maximum amount of available energy that is available for supply.

At step 535 of method 500, the vehicle control system 100 is configured to determine, based on the load shedding operation, whether current supply to the accessories 80 should be adjusted. Specifically, the vehicle control system 100 may determine, based on the current demand of each individual accessory 80, whether to adjust current supply to none of the accessories 80, a subset of the accessories 80, or all the accessories 80. In some embodiments, the determination is based on the difference between the SOC and the predetermined threshold. For example, the number of accessories 80 to receive an adjusted supply of current may be higher if the difference between the SOC and predetermined threshold is relatively large.

At step 540 of method 500, if the vehicle control system 100 determines that a subset/all of the accessories 80 should receive an adjusted supply of current, the vehicle control system 100 transmits an instruction to adjust the supply of current to the accessories 80. By way of example, the vehicle control system 100 may transmit an instruction to the accessories 80 to demand less current from the battery system. By way of another example, the vehicle control system 100 may transmit an instruction to the accessories 80 to adjust the functionality (e.g., operations) of the accessories 80 to function at a lower current demand.

At step 545 of method 500, the vehicle control system 100 is configured to determine, based on the load shedding operation, whether current supply to the prime mover 52 should be adjusted. In some embodiments, the determination is based on the difference between the SOC and the predetermined threshold. For example, if the difference between the SOC and predetermined threshold is relatively large, a more drastic load shedding operation may be necessary, resulting in adjusting the prime mover 52. In some embodiments, the determination is based on previous load shedding operations. For example, if the accessories 80 have already been disabled and further load shedding is necessary, the vehicle control system 100 may determine that the prime mover 52 should also be adjusted.

At step 550 of method 500, if the vehicle control system 100 determines that the prime mover 52 should receive an adjusted supply of current, the vehicle control system 100 transmits an instruction to the prime mover 52 to adjust the supply of current to the prime mover 52. By way of example, the vehicle control system 100 may transmit an instruction to the prime mover 52 to demand less current from the battery system. Specifically, the instruction may instruct the prime mover 52 to reduce a maximum speed or an acceleration rate such that the prime mover 52 can function at a lower current demand.

At step 555 of method 500, the vehicle control system 100 is configured to determine, based on the load shedding operation, whether settings of the battery system should be adjusted to shed loads to the accessories 80 and/or the prime mover 52. Specifically, the battery system may be adjusted to place artificial limits on the supply of current from the battery to the accessories 80 and/or the prime mover 52. By way of example, the vehicle control system 100 may adjust the BMS 112 to allow a limited supply of current to be delivered to the vehicle 10 components, where the limited supply is less than a normal (e.g., rated, default) supply of current. This operation may be done in addition or alternatively to the adjustments to the prime mover 52 and/or the accessory 80.

At step 560 of method 500, if the vehicle control system 100 determines that battery system (e.g., BMS 112) setting should be adjusted, the vehicle control system 100 transmits an instruction to the battery system (e.g., via the BMS 112) to place an artificial limit on current supply. By way of example, the vehicle control system 100 may transmit an instruction to the BMS 112 to supply less current to the accessories 80. Specifically, the instruction may instruct the BMS 112 to reduce current supply such that the battery system can decrease its discharge rate. In some embodiments, the BMS 112 is configured to indirectly reduce the current supplied by the battery system. For example, the BMS 112 may instruct the motor controller 110 to reduce a current limit to the motor 53, thereby reducing the current output of the battery system.

The vehicle control system 100 may then receive sensor data from the sensors 90 (e.g., as described in step 505). Continuous reception of sensor data from the sensors 90 creates a feedback loop that allows continuously monitoring and adjustment of load shedding operations of the vehicle 10. For example, after adjusting the accessories 80, prime mover 52, and/or battery system, method 500 may be repeated to determine whether further adjustments should be made.

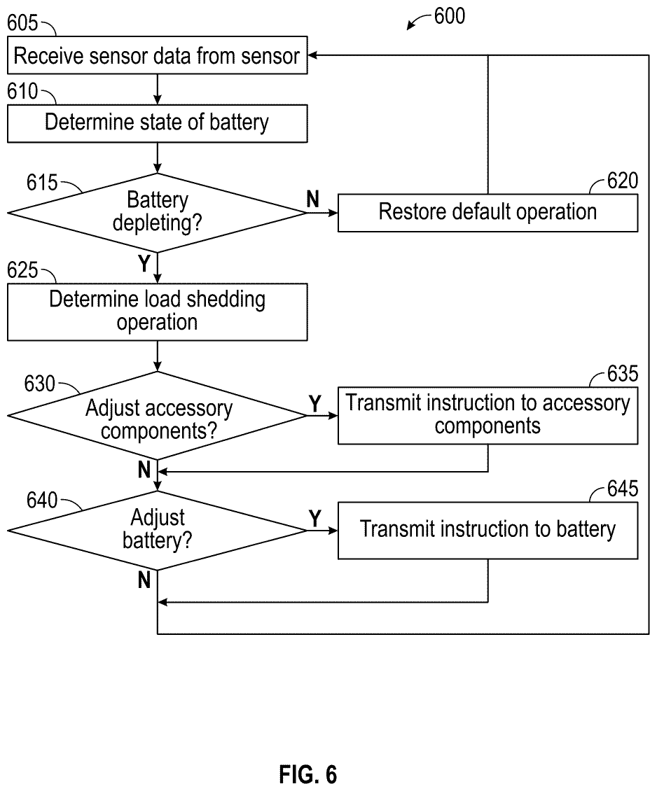

As shown in FIG. 6, depicted is a flow diagram of a method 600 for electrical load shedding for the vehicle 10 where the prime mover 52 of the driveline 50 includes an internal combustion engine. At step 605 of method 600, the vehicle control system 100 receives sensor data from the sensors 90. Specifically, the vehicle control system 100 receives sensor data from the sensors 90 regarding the current output of the battery system (e.g., energy storage 54, battery module 57, etc.) relative to the current input of the battery system. In some embodiments, the sensor data includes voltage measurements from the battery system. The motor controller 110, the BMS 112, and/or the processing circuit 102 may be configured to receive the sensor data. The sensor data may be collected by the motor controller sensor 114, the BMS sensor 116, and/or a different sensor 90.

At step 610 of method 600, the vehicle control system 100 is configured to determine a SOC of the battery system. The vehicle control system 100 may be configured to use the sensor data (e.g., from BMS sensor 116, motor controller sensor 114, and/or other sensors 90) to determine the current input to the battery system relative to the current output of the battery system. By way of example, the vehicle control system 100 may analyze voltage measurements to determine whether the voltage of the battery is decreasing. From this, the vehicle control system 100 may be configured to infer or otherwise determine the net current input/output of the battery system. In some embodiments, the SOC of the battery corresponds to a percentage of remaining battery capacity. In other embodiments, the SOC of the battery system may correspond to the rate of charge/discharge of the battery system.

At step 615 of method 600, the vehicle control system 100 is configured determine whether the battery system is being depleted (e.g., walked down). In some embodiments, this includes comparing the SOC of the battery to a predetermined threshold. The predetermined threshold may correspond to a SOC where battery is being degraded (e.g., walked down, depleted) by the accessories 80. By way of example, the threshold may be based on a SOC where the battery cannot power a starter motor to start an internal combustion engine. In other embodiments, the vehicle control system 100 may determine that the battery is being depleted based on a voltage of the battery. If the vehicle control system 100 determines that the battery system is not being depleted, the vehicle control system 100 is configured to receive sensor data until the battery is depleting.

At step 620 of method 600, if the battery is not depleting (e.g., battery SOC is above threshold), the vehicle control system 100 is configured to restore default operation of the vehicle 10. Specifically, restoring default operation of the vehicle 10 may include restoring normal (e.g., default, rated) supply of current to the accessories 80. By way of example, restoring default operation of the vehicle 10 may include restoring normal (e.g., default) settings of the BMS 112, and removing any artificial limits on the supplying of current from the battery system. After restoring default operation, steps 605-615 may be repeated to achieve active monitoring of the vehicle 10.

At step 625 of method 600, if the battery is depleting, the vehicle control system 100 is configured to determine a load shedding operation for the vehicle 10. In some embodiments, the load shedding operation includes adjusting or otherwise limiting a supply of current to one or more accessories 80 to decrease the amount of current being drawn from the battery system. Specifically, adjusting current to the accessories 80 may decrease the discharge rate of the battery system. This may allow additional runtime for the prime mover 52 to operate and generate current for supply to the battery system (e.g., via an alternator, via the electric motor 53, etc.).

In some hybrid vehicle 10 configurations, the load shedding operation may include adjusting or otherwise limiting an electric motor of the primary driver 52 to decrease the amount of current drawn from the battery system. For example, this may include decreasing the functionality of the electric motor, such as the maximum speed and/or acceleration rate. As another example, this may include disabling the electric motor, such that only the internal combustion engine is operational in the prime mover 52. In some embodiments, the load shedding operation includes adjusting or otherwise limiting the battery system to limit the amount of current being supplied to the electric motor. Specifically, the BMS 112 may place an artificial limit on the supply of current to electric motor, the artificial limit being less than the maximum amount of available energy that is available for supply.

At step 630 of method 600, the vehicle control system 100 is configured to determine, based on the load shedding operation, whether current supply to the accessories 80 (and/or the electric motor) should be adjusted. Specifically, the vehicle control system 100 may determine, based on the current demand of each individual accessory 80, whether to adjust current supply to none of the accessories 80, a subset of the accessories 80, or all the accessories 80. In some embodiments, the determination is based on the difference between the SOC and the predetermined threshold. For example, the number of accessories 80 to receive an adjusted supply of current may be higher if the difference between the SOC and predetermined threshold is relatively large.

At step 635 of method 600, if the vehicle control system 100 determines that a subset/all of the accessories 80 should receive an adjusted supply of current, the vehicle control system 100 transmits an instruction to adjust the supply of current to the accessories 80. By way of example, the vehicle control system 100 may transmit an instruction to the accessories 80 to demand less current from the battery system. By way of another example, the vehicle control system 100 may transmit an instruction to the accessories 80 to adjust the functionality (e.g., operations) of the accessories 80, such that the accessories 80 function at a lower current demand.

At step 640 of method 600, the vehicle control system 100 is configured to determine, based on the load shedding operation, settings of the battery system should be adjusted to shed loads to the accessories 80. Specifically, the battery system may be adjusted to place artificial limits on the supply of current from the battery to the accessories 80. By way of example, the vehicle control system 100 may adjust the BMS 112 to allow a limited supply of current to be delivered to the vehicle 10 components, where the limited supply is less than a normal (e.g., rated, default) supply of current. This operation may be done in addition or alternatively to accessory 80 adjustments.

At step 645 of method 600, if the vehicle control system 100 determines that battery system (e.g., BMS 112) setting should be adjusted, the vehicle control system 100 transmits an instruction to the battery system (e.g., via the BMS 112) to place an artificial limit on current supply. By way of example, the vehicle control system 100 may transmit an instruction to the BMS 112 to supply less current to the accessories 80. Specifically, the instruction may instruct the BMS 112 to reduce current supply such that the battery system can decrease its discharge rate. [85] The vehicle control system 100 may then receive sensor data from the sensors 90 (e.g., as described in step 605). Continuous reception of sensor data from the sensors 90 creates a feedback loop that allows continuously monitoring and adjustment of load shedding operations of the vehicle 10. For example, after adjusting the accessories 80, prime mover 52, and/or battery system, method 600 may be repeated to determine whether further adjustments should be made.

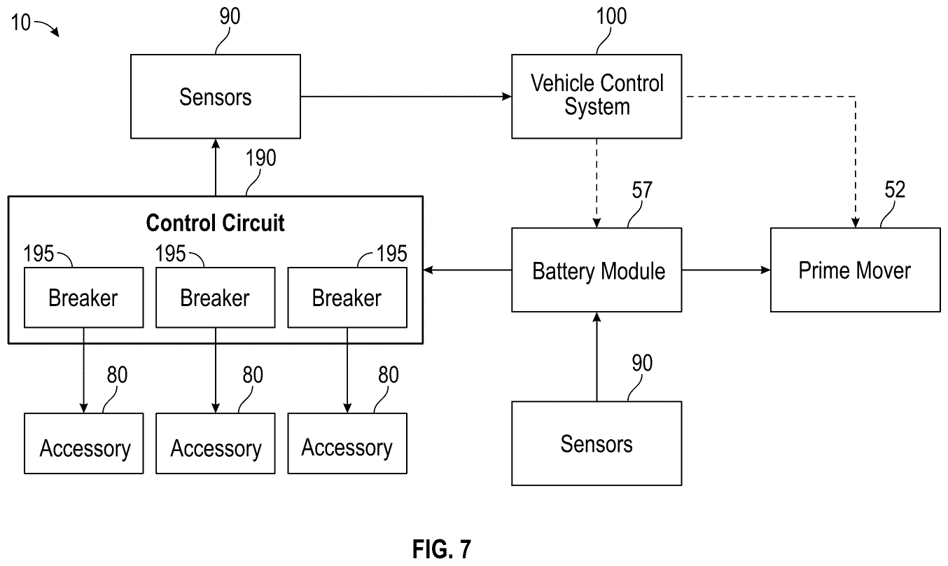

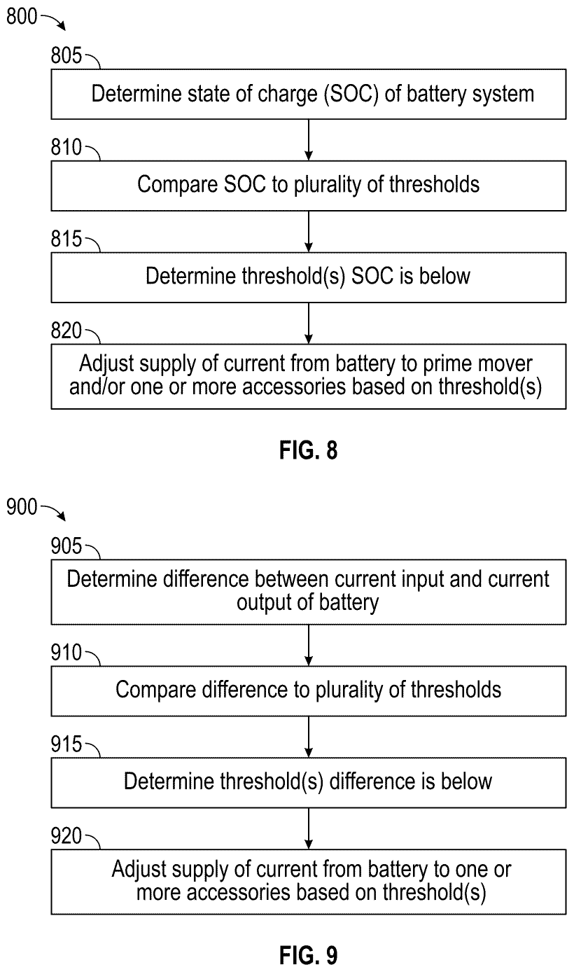

As shown in FIG. 7, the vehicle 10 includes a control circuit 190 between the battery system (e.g., battery module 57) and the accessories 80. The control circuit 190 includes one or more isolators, shown as breakers 195. In some embodiments, the control circuit 190 includes the motor controller 110 and/or the BMS 112. The breakers 195 may be configured to allow/disable current to be supplied from the battery system to the accessories 80. According to the exemplary embodiment shown, each accessory 80 is coupled to a respective breaker 195. In other embodiments, one breaker 195 is coupled to a plurality of accessories 80. The breakers 195 may include at least one of a relay, a switch, and/or a diode.

The breakers 195 are configured to be in an open position when the battery system is below a threshold voltage, thereby disconnecting the accessory 80 from the battery system. The threshold voltage may be based on desired operations of the vehicle 10. In some embodiments, the predetermined threshold corresponds to a SOC where the discharge rate of the battery system should be decreased to prolong an amount of time that the prime mover 52 can operate. By way of example, the predetermined threshold may correspond to a SOC where the discharge rate of the battery system should be decreased to ensure the prime mover 52 can move the vehicle 10 to a charging station. By way of another example, the predetermined threshold may correspond to a SOC where the discharge rate of the battery system should be decreased to ensure the prime mover 52 can operate for an amount of time set by the operator (e.g., via interaction with the operator interface 48.

When a respective breaker 195 is open, current is unable to be supplied (e.g., flow, be transmitted) from the battery system to the one or more accessories 80 associated with the respective breaker 195. This may reduce the total (e.g., net) current being supplied from the battery system to the rest of the vehicle 10. For hybrid/electric motor prime mover 52 vehicles 10, opening the breakers 195 can decrease the discharge rate of the battery system. This may allow for an increase in the proportion of the SOC of the battery available to the prime mover 52 for use, thereby increasing the amount of time that the prime mover 52 can operate before the battery system is fully depleted. For hybrid and/or internal combustion engine prime mover 52 vehicles 10, opening the breakers 195 can decrease the discharge rate of the battery system. By way of example, this may allow for the conservation of current to be used for starting the prime mover 52. By way of another example, this may allow more time for a generator of the prime mover 52 to generate current to charge the battery.

In some embodiments, the breakers 195 all have the same voltage threshold. Specifically, each breaker 195 is configured to open at the same battery voltage. This may result in all of the accessories 80 being disabled when the battery system is at a certain voltage. In other embodiments, the breakers 195 have different voltage thresholds. Specifically, each breaker 195 or group of breakers 195 is configured to open at a different voltage. This may result in the accessories 80 being disabled in tiers. By way of example, the voltage thresholds may be set or otherwise determined based on importance (e.g., essentialness, utility, value) to the user. Specifically, the accessories 80 that are least valuable to the user or vehicle operations can be set to be disabled first, and the accessories 80 that are most valuable to the user or vehicle operations can be set to be disabled last. This may allow for minimal interruption to user experience when shedding loads.

In some embodiments, the breakers 195 are configured to open automatically below the threshold voltage and/or close automatically above the threshold voltage. This may allow or otherwise enable automatic load shedding and reconnecting by the breakers 195. In other embodiments, the breakers 195 are configured to open automatically, but must be closed manually (e.g., by an operator of the vehicle 10). By way of example, when the battery system falls below the threshold voltage, the breakers 195 may open automatically, but may need to be closed by the operator of the vehicle 10 when the vehicle 10 is stopped (e.g., at rest).

As shown in FIG. 7, the sensors 90 are electrically coupled to the control circuit 190. The sensors 90 may collect data regarding operation of the breakers 195. By way of example, the sensors 90 may be configured to detect whether the breakers 195 are open and/or closed. The sensors 90 are configured to transmit the sensor data to the vehicle control system 100. The vehicle control system 100 may analyze or otherwise process the sensor data to actively monitor the breakers 195. In some embodiments, the vehicle control system 100 is configured to adjust the supply of current from the battery to the prime mover 52 in response to determining that the breaker is open. The vehicle control system 100 may include a motor controller (e.g., the motor controller 110) and/or a BMS (e.g., the BMS 112) configured to adjust the supply of current from the battery to the prime mover 52. By way of example, the vehicle control system 100 may determine that one or more of the breakers 195 are open and transmit an instruction to the BMS to place an artificial limit on the battery system. By way of another example, the vehicle control system 100 may determine that one or more breakers 195 are open and transmit an instruction to the motor controller to reduce a maximum speed and/or acceleration of the prime mover 52.

As shown in FIG. 7, the sensors 90 are coupled to the battery module 57 (e.g., the battery system). The sensors 90 may be configured to collect sensor data regarding operation of the battery module 57. By way of example, the sensors 90 may collect data regarding the voltage of the battery module 57. The sensors 90 may transmit the sensor data to the vehicle control system 100, thereby allowing the vehicle control system 100 to simultaneously monitor the control circuit 190 and the battery module 57. This may allow the vehicle control system 100 to determine whether the breakers are operating properly. For example, if a breaker 195 opens, but the battery system is not at the threshold voltage, the vehicle control system 100 may determine that the breaker 195 may be faulty and should be replaced.

It should be understood that the embodiments described herein regarding FIG. 7 are configured to be applied to any of a prime mover 52 with an electric motor, an internal combustion engine, or a combination of both. The prime mover 52 may include a generator configured to generate current to be supplied to the battery system. The battery system (e.g., battery module 57) may supply current to the prime mover 52 for purposes or operating an electric motor, or supplying current to start an internal combustion engine.

As shown in FIG. 8, depicted is a flow diagram of a method 800 for dynamic electrical load shedding for the vehicle 10 with an electric motor prime mover 52. At step 805 of method 800, the vehicle control system 100 is configured to determine a SOC of the battery system (e.g., the battery module 57). In some embodiments, the SOC of the battery system corresponds to a percentage of remaining battery capacity. In other embodiments, the SOC of the battery system may correspond to a remaining drive time of the vehicle 10. To determine the SOC of the battery system, in some embodiments, the vehicle control system 100 compares the voltage of the battery to a rated voltage to determine the SOC of the battery system. In other embodiments, the vehicle control system 100 analyzes a look up table to determine a SOC based on the voltage of the battery system.

At step 810 of method 800, the vehicle control system 100 is configured to compare the SOC to a plurality of thresholds. The plurality of thresholds may be based on desired operations of the vehicle 10. In some embodiments, at least one threshold corresponds to a SOC where the discharge rate of the battery system should be decreased to prolong an amount of time that the prime mover 52 can operate. In some embodiments, at least one threshold corresponds to a SOC where the discharge rate of the battery system should be decreased to ensure the prime mover 52 can move the vehicle 10 to a charging station. In some embodiments, at least one threshold corresponds to a SOC where the discharge rate of the battery system should be decreased to ensure the prime mover 52 can operate for an amount of time set by the operator (e.g., via interaction with the operator interface 48).

At step 815 of method 800, the vehicle control system 100 is configured to determine which threshold(s) of the plurality of thresholds that the SOC of the battery system is below. Each threshold may correspond to a different SOC. For example, a first threshold may correspond to a SOC that corresponds to a remaining 30% charge of the battery system, and a second threshold may correspond to a SOC that corresponds to a remaining 15% charge of the battery system. Each threshold may correspond to one or more accessories 80 and/or the prime mover 52. Specifically, at each threshold, additional accessories 80 and/or the prime mover 52 may be adjusted. For example, when a first threshold is reached, a first accessory 80 may be adjusted, when a second threshold is reached, a second accessory 80 may be adjusted, and when a third threshold is reached, the prime mover 52 may be adjusted.

At step 820 of method 800, the vehicle control system 100 is configured to adjust the supply of current to the prime mover 52 and/or the accessories 80 based on the threshold(s). Specifically, the vehicle control system 100 is configured to adjust the current supplied to the accessories 80 and/or the prime mover 52, based on a determination of (a) which of the accessories 80 and/or the prime mover 52 to adjust current supply to, and (b) the magnitude of the adjustment. The determination of whether to adjust current supply and/or the magnitude of the adjustment may be based on the threshold(s). By way of example, a first threshold may correspond to a first adjustment for an accessory 80, and a second threshold may correspond to a second adjustment for the same accessory 80. By way of another example, a first threshold may correspond to a first adjustment for one or more first accessories 80, a second threshold may correspond to an adjustment for one or more second accessories 80, a third threshold may correspond to an adjustment to one or more third accessories 80 and/or the prime mover 52, etc.

As shown in FIG. 9, depicted is a flow diagram of a method 900 for dynamic electrical load shedding for a vehicle 10 with an internal combustion engine prime mover 52. At step 905 of method 900, the vehicle control system 100 is configured to determine a difference between a current input (e.g., due to charging and/or generation) and current output (e.g., due to providing current to the prime mover 52 and/or accessories 80) of the battery system (e.g., BMS 112 and/or battery module 57). In some embodiments, the difference corresponds to a voltage of the battery system. In some embodiments, the difference corresponds to current measurements at the input of the battery system and an output port of the battery system. For example, a first sensor 90 may detect the current input of the battery system and a second sensor 90 may detect a current output of the battery system. As another example, a single sensor 90 may be placed at a terminal of the battery system to detect net current (e.g., input/output) of the battery system.

At step 910 of method 900, the vehicle control system 100 is configured to compare the difference to a plurality of thresholds. The plurality of thresholds may be based on desired operations of the vehicle 10. In some embodiments, the at least one threshold corresponds to a current difference where the discharge rate of the battery system should be decreased to ensure that the battery has enough stored current to start the prime mover 52. In some embodiments, at least one threshold corresponds to a SOC where the discharge rate of the battery system should be decreased to allow more time for a generator/alternator of the vehicle 10 to supply current to the battery system.

At step 915 of method 900, the vehicle control system 100 is configured to determine which of the threshold(s) of the plurality of thresholds that the current difference of the battery system is below. Each threshold may correspond to a different current difference. For example, a first threshold may correspond to a current difference that corresponds one discharge rate, and a second threshold may correspond to a current difference that corresponds to a second discharge rate. Each threshold may correspond to one or more accessories 80. Specifically, at each threshold, additional accessories 80 may be adjusted. For example, at a first threshold a first accessory 80 may be adjusted, at a second threshold a second accessory 80 may be adjusted, at a third threshold a third accessory 80 may be adjusted, etc.

At step 920 of method 900, the vehicle control system 100 is configured to adjust the supply of current to one or more accessories 80 based on the threshold(s). Specifically, the vehicle control system 100 is configured to adjust the current supplied to the accessories 80, based on a determination of (a) which accessories 80 to adjust current supply, and (b) the magnitude of the adjustment. The determination of whether to adjust current supply and/or the magnitude of the adjustment may be based on the threshold(s). By way of example, a first threshold may correspond to a first adjustment for a first accessory 80, and a second threshold may correspond to a second adjustment for the first accessory 80. As another example, a third threshold may correspond to a third adjustment for a second accessory 80, and a fourth threshold may correspond to a fourth adjustment for a fourth accessory 80.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, the vehicle control system 100, etc.) and the fleet monitoring and control system 200 (e.g., the remote systems 240, the user portal 230, the user sensors 220, etc.) as shown in the various exemplary embodiments is illustrative only. Additionally, any element disclosed in one embodiment may be incorporated or utilized with any other embodiment disclosed herein.

1. A recreational vehicle comprising:
a prime mover;
an accessory;
a battery configured to supply current to the prime mover;
a sensor configured to acquire sensor data regarding operation of the battery; and
a control system configured to:
determine, based on the sensor data, a state of charge (SOC) of the battery; and
reduce a supply of current from the battery to the accessory, responsive to a determination that the SOC is below a predetermined threshold, thereby decreasing a discharge rate of the battery and increasing a proportion of the SOC of the battery available to the prime mover.

2. The recreational vehicle of claim 1, wherein the control system is configured to reduce the supply of current from the battery to the accessory by at least one of (a) decreasing a current demand of the accessory, or (b) placing a limit on an amount of current supplied by the battery to the accessory.

3. The recreational vehicle of claim 1, wherein the supply of current is a first supply of current, and wherein the control system is configured to reduce a second supply of current from the battery to the prime mover, responsive to a determination that the SOC is below at least the predetermined threshold.

4. The recreational vehicle of claim 3, wherein the predetermined threshold is a first predetermined threshold, wherein the control system is configured to reduce the second supply of current from the battery to the prime mover responsive to a determination that the SOC is below the first predetermined threshold and a second predetermined threshold, and wherein the second predetermined threshold is associated with a lower SOC than the first predetermined threshold.

5. The recreational vehicle of claim 3, wherein the control system is configured to decrease a current demand of the prime mover by decreasing a maximum speed of the prime mover to reduce the second supply of current to the prime mover.

6. The recreational vehicle of claim 3, wherein the control system is configured to adjust the second supply of current from the battery to the prime mover by at least one of (a) decreasing a current demand of the prime mover, or (b) placing a limit on an amount of current supplied by the battery to the prime mover.

7. The recreational vehicle of claim 3, comprising an operator interface configured to transmit instructions to the control system, wherein the control system is configured to:
receive an instruction from the operator interface indicating that at least one of (a) the first supply of current from the battery to the accessory or (b) the second supply of current from the battery to the prime mover should not be reduced; and
disable reduction of the at least one of (a) the first supply of current or (b) the second supply of current based on the instruction.

8. The recreational vehicle of claim 3, wherein the control system is configured to:
disable the first supply of current to the accessory or the second supply of current to the prime mover after a predetermined time of inactivity of the prime mover; and
adjust the predetermined time of inactivity responsive to a determination that the SOC is below at least the predetermined threshold.

9. The recreational vehicle of claim 1, wherein the prime mover facilitates regenerative braking to charge the battery, and wherein the control system is configured to:
determine, based on the sensor data, that the SOC has increased such that the SOC is above the predetermined threshold; and
increase the supply of current from the battery to the accessory at least in response to the SOC being greater than the predetermined threshold.

10. The recreational vehicle of claim 9, wherein the predetermined threshold is a first predetermined threshold, wherein the control system is configured to increase the supply of current from the battery to the accessory responsive to a determination that the SOC is above the first predetermined threshold and a second predetermined threshold, and wherein the second predetermined threshold is associated with a higher SOC than the first predetermined threshold.

11. The recreational vehicle of claim 1, wherein the accessory is one of a plurality of accessories, wherein the control system is configured to adjust the supply of current from the battery to each of the plurality of accessories based on a type of each of the plurality of accessories.

12. The recreational vehicle of claim 1, wherein the control system includes a motor controller configured to reduce the supply of current from the battery to the accessory, responsive to the determination that the SOC is below the predetermined threshold.

13. The recreational vehicle of claim 1, wherein the control system is configured to adjust the predetermined threshold based on a degradation value associated with the battery, wherein the degradation value is based on at least one of a maximum capacity, an efficiency rate, or a discharge rate of the battery.

14. The recreational vehicle of claim 1, wherein the SOC is based on a measured voltage of the battery relative to a rated voltage of the battery, and wherein the sensor data comprises voltage measurements from the battery.

15. The recreational vehicle of claim 1, wherein the recreational vehicle is a golf vehicle, an all-terrain vehicle, a utility task vehicle, a hauler, or a turf mower.

16. A vehicle comprising:
an electric motor;
an accessory;
a battery configured to provide a supply of current to the electric motor and the accessory; and
a control system including at least one of:
(a) a breaker positioned between the battery and the accessory, the breaker configured to be in an open position when a voltage of the battery is below a voltage threshold to stop the supply of current to the accessory; or
(b) a motor controller configured to reduce the supply of current from the battery to the electric motor in response to at least one of (i) a determination that the breaker is open or (ii) the voltage indicating that a state of charge (SOC) of the battery is below a SOC threshold.

17. The vehicle of claim 16, wherein the control system includes the breaker and the motor controller.

18. The vehicle of claim 17, wherein the motor controller is configured to increase the supply of current from the battery to the electric motor in response to the voltage indicating that the SOC of the battery is above at least the SOC threshold.

19. The vehicle of claim 16, wherein the control system includes the breaker, and wherein the breaker includes at least one of a relay, switch, or diode.

20. A vehicle system comprising:
a non-transitory computer-readable medium having instructions stored thereon that, when executed by one or more processors, cause the one or more processors to:
determine a state of charge (SOC) of a battery of a golf vehicle, the SOC corresponding to a voltage of the battery;
compare the SOC of the battery to a first predetermined threshold;
reduce a first supply of current from the battery to a first accessory of the golf vehicle in response to the SOC being less than the first predetermined threshold;
compare the SOC of the battery to a second predetermined threshold, the second predetermined threshold corresponding to a lower SOC than the first predetermined threshold; and
reduce a second supply of current to at least one of a second accessory or an electric motor of the golf vehicle in response to the SOC being less than the second predetermined threshold.
